(19) United States
(12) Patent Application Publication
(10) Pub. No.: US 2008/0230687 A1
(43) Pub. Date: Sep. 25, 2008

(54) Automatic Analysis Device and Method for Monitoring Polymer Production by Means of Mass Spectroscopy

(75) Inventor: Rudolf Kampf, Haingrundau (DE)

Correspondence Address: MICHAEL BEST & FRIEDRICH LLP, 100 E WISCONSIN AVENUE, Suite 3300, MILWAUKEE, WI, 53202, US

(73) Assignee: Zimmer Aktiengesellschaft, Frankfurt am Main (DE)

(21) Appl. No.: 10/575,142

(22) PCT Filed: Sep. 23, 2004
(86) PCT No.: PCT/EP04/10677

§ 371 Date: Sep. 20, 2006

(30) Foreign Application Priority Data
Oct. 6, 2003 (DE) 103 46 769.6

(51) Int. Cl. H01J 49/26

(52) U.S. Cl. 250/282; 250/288

(57) ABSTRACT

The invention relates to a method, which is used to monitor the composition of a polymer blend, melt and/or solution used to produce a polymer and to an automatic analysis device (27). To produce the polymer, the polymer blend, melt and/or solution is guided through an installation volume and a sample gas that is formed from said polymer blend, melt and/or solution is withdrawn, preferably at several sampling sites (30 to 36). The sample gas is fed to a mass spectrometer (28), which automatically emits an analysis signal representing the composition of the sample gas. The sampling site is connected to the mass spectrometer in a switchable manner via an automatically switchable shut-off device (47, 48), in such a way that several sampling sites can be sampled in succession by the mass spectrometer (28). The use of the mass spectrometer (28) permits an extremely accurate analysis of the composition of the sample gas and precise control of the process parameters of the reactor systems that are used for the polymer production. Said method and automatic analysis device can be used, in particular, during a polycondensation process.

The invention relates to a method in which a composition of a polymer blend, melt and/or solution used to produce a polymer is monitored, wherein the polymer blend, melt and/or solution is guided through an installation volume during the production, and gases or vapours that form from the polymer blend, melt and/or solution are withdrawn from the installation volume and fed to a mass spectrometer, which automatically outputs an analysis signal representing the composition of the sample gas.

The invention furthermore relates to an automatic analysis device that is developed in such a way that it can be built into an installation for the production of a polymer from a polymer blend, melt and/or solution that is guided through an installation volume, having at least one gas line which is developed in such a way that it can be connected to the installation volume in a way that allows fluids to be conducted, and having at least one mass spectrometer to which the sample gases and/or sample vapours formed from the polymer blend, melt and/or solution can be fed via the gas line, wherein an analysis signal that is representative for the composition of the sample gases or sample vapours can be outputted by the mass spectrometer.

In industrial plastic production, large quantities of polymers are produced in installations that work continuously. The manufacturing processes carried out in these installations are characterised by various processing stages and reactor systems, as well as apparatuses.

Polymers make up a considerable portion of the millions of tons of plastic products produced each year. These polymers are formed from monomers by means of a condensation process with the separation of cleavage groups, or so-called polycondensation. Ring-opening reactions in which no separation occurs during the chain growth are also assigned to this group. The greater portions of polycondensation polymers are produced from dicarboxylic acids, esters thereof, carboxylic acid esters and dialcohols, bisphenols or diamines. Hydroxycarboxylic acids, cyclic esters thereof or monomers in the form of lactams or lactones are also suitable as additional substance groups. Among the most frequently used components in the acid-based substances are terephthalic, adipic, phthalic and isophthalic acids, and, more rarely, maleic, succinic, glutaric, azelaic and sebacic acids or fatty acids of higher valency.

Among the esterified monomers, only dimethyl terephthalate and diphenyl carbonate have become significantly important, wherein the former has only been produced subordinately in the last 15 years with the emergence of direct esterification of the diacids, and, in recent times, the latter has gained in importance for the melt condensation of polycarbonate.

In the case of alcoholic, phenolic or aminic monomers, preferred for use are ethylene glycol, diethylene glycol, isomeric propylene and butylene glycols, bisphenol A and hexamethylenediamine, and, less frequently, neopentyl glycol and 1,6 hexanediol or longer-chain amines and phenols.

Depending on the monomers used, polyesters with very different properties result. In order to adapt the application properties for special properties by means of long-chain and short-chain or star-like or bush-like branchings, tri-functional or multi-functional acid, hydroxyl, phenyl or amine derivatives are added. Because these change the functional properties dramatically in high concentrations, one uses them only in small doses. Among the most popular branchers are glycerine, pentaerythritol, trimethylolethane, trimethylamine, trimellitic acid and pyrogallol.

The linking of the abovementioned monomers into long-chain polymer molecules takes place only by means of a reversible equilibrium reaction, which is controlled by the removal of the cleavage products, such as water, methanol, phenol or ammonia, released during the polycondensation. In the case of direct esterification of acids, the chief product at the start is water, until all functional groups have been saturated. Because complete stoichiometric saturation is scarcely attainable given the installation management and the various thermodynamic states and behaviour patterns of the monomers, a preponderance of one monomer terminal group or the other emerges. As a rule, one selects the components that are easier to remove for the hyperstoichiometric portion, or the components with the highest partial vapour pressure.

The removal of the group with the highest partial vapour pressure is then done at elevated temperatures and, if this is not sufficient, at lowered pressure and in thin layers.

The methods for increasing the temperature and for generating a vacuum that are used in this process are known from the general process technology. A large number of various apparatuses are used to create thin layers and larger surfaces. The quality of these processes has a considerable influence on the further progress of the reaction.

In addition to the primary or main reaction, secondary reactions also take place, which are caused by the thermodynamic stability of the monomers and secondary by-products, such as polyethers, cyclic ethers, cyclic polymers and intermolecular and intramolecular rearrangement reactions. Known, undesired by-products of polymer production are, for example, acetaldehyde, polyether glycols, tetrahydrofurane, dioxanes, acroleins, dioxalanes and ammonia, as well as amines and imines. Particularly undesirable are migrations of substituents, analogous, for example, resulting form the Fries rearrangement or the Kolbe-Schmitt reaction. The secondary reactions must be suppressed or reduced to a minimum by means of adjusting the process parameters that define the process control. These process parameters comprise, for example, the temperature, the retention time and the pressure in the reactor system and the concentration and portions of the components in the polymer blend, melt and/or solution, to the extent that the latter can be influenced or changed in the reactor system.

Devices and methods of the type mentioned at the beginning are known in the state of the art. For example, samples are taken manually during polymer production at various sampling sites in the installation. The manually withdrawn samples are then carried by hand to a gas chromatograph or to a mass spectrometer and analysed there. This type of sampling is tedious and costly.

A more rapid analysis of the by-products and cleavage products, as well as the vapours, can be achieved by building into the installation sensors that monitor the installation volume directly.

For example, in U.S. Pat. No. 5,208,544, a ring-shaped, dielectric sensor and a continuous measurement procedure are described, by means of which the viscosity of a polymer can be determined subject to the dielectric loss factor. The sensor generates alternating electromagnetic fields with frequencies between 0.5 Hz and 200 kHz. Detrimental in the sensor in U.S. Pat. No. 5,208,544 is that it is only suitable for conduits with an inside diameter of a maximum of 8 cm. A conduit diameter of this type is too small for large industrial applications, however.

Another measurement principle for polymers or polymer solutions that is based on alternating electromagnetic fields is known from U.S. Pat. No. 4,448,943, on the basis of which the sensor and the measurement procedure of the above-mentioned U.S. Pat. No. 5,208,544 was developed. In U.S. Pat. No. 4,448,943, there is likewise a description of the manner in which the dielectric constant of a polymer is determined by means of an alternating electromagnetic field. The process parameters, by means of which the manufacturing process of the polymer is defined in the various stages, are controlled in dependence on the dielectric constant in such a way that the measured dielectric constant approaches a pre-defined target dielectric constant of the polymer. In addition to the dielectric constant, a dissipation factor can additionally be calculated for controlling the polymer composition, and can be drawn on for determining the state of the polymer. According to the theory of U.S. Pat. No. 4,448,943, at frequencies below 20 kHz, the dielectric constant is heavily influenced by ionic impurities, so that this frequency range can be drawn on for checking the composition of the polymer. At frequencies between 20 kHz and 1 MHz, the dielectric constant attains a constant value that is typical for the material.

A method and a device for the identification of plastics with the help of mass spectrometry is described in DE-A-42 00 497. The device has a mass spectrometer with a special sampling head. The sampling head contains a sensor tube, which is connected to an inert gas source, and a laser light guide. In the method according to DE-A-42 00 497, a plastic sample is partially pyrolitically broken down and the resulting breakdown products are transported to the mass spectrometer and identified there.

Detrimental in the sampling sensor of DE-A-42 00 407 is that it is not developed in such a way as to allow installation into a system for polymer production. Furthermore, unlike in the case of the invention under consideration, in DE-A-42 00 497, a finished plastic is examined, and not a polymer blend for the production of a polymer. Furthermore, DE-A-42 00 497 does not disclose any installation volume through which a polymer blend, melt and/or solution is guided, and from which a gas formed from the polymer blend is guided to a mass spectrometer via a gas line that can be connected to the installation volume in a way allowing fluids to be conducted.

From EP-A-0 572 848 and U.S. Pat. No. 3,959,341, methods and devices are known in which sample gases are guided to a mass spectrometer. In EP A-0 572 848, the exhaust gas components from oxygen converters are examined in steel production, in order to determine the end point of the refining. In U.S. Pat. No. 3,959,341, the effluent process gas of a nitrile synthesis is guided to a mass spectrometer in order to check and optimise the synthesis process. The methods of EP-A-0 579 055 and U.S. Pat. No. 3,959,341 cannot be used for monitoring a polymer blend, melt and/or solution that is used for the production of a polymer. In neither of these publications is a gas formed from a polymer blend withdrawn and fed from the installation volume to the mass spectrometer through a gas line.

In the state of the art, it is additionally known to use the index of refraction of a polymer solution containing water, cellulose and tertiary amine oxide as an indicator of the state of the polymer solution. A method of this kind or a device of this kind is described, for example, in EP-B-0 700 458. According to this publication, the index of refraction of the polymer solution should be representative for the concentration of the water portion in the cellulose solution. For controlling the production process, valves that regulate the water component in the polymer solution are operated, depending on the measured index of refraction. In this way, the composition of the polymer solution is controlled in dependence on the index of refraction in such a way that an index of refraction that is representative for a target state of the polymer solution is measured. A restriction must be noted with regard to this method, however, because in the case of a ternary mixture, a measurement of the index of refraction is only capable of recording one of the three components, and of recording this component only within a fixed concentration.

In U.S. Pat. No. 5,155,184, it is described that the molecular structure of a polymer can be determined by means of absorption measurements using an infrared spectrophotometer. The substance flows fed to a reactor and the emptying cycles of the reactor are controlled in dependence on the result of the absorption measurements. According to U.S. Pat. No. 5,155,184, this method is suitable for controlling the polymerisation of one or more olefinic or vinyl monomers.

The disadvantage of the methods of EP-B-0700458 and U.S. Pat. No. 5,155,184, as in all methods based on visual measurements, lies in the fact that, at measurement sites, light-permeable areas must be built into the outer wall of the installation volume or reaction volume through which the polymer is guided during the production, without which no visual examination of the polymer in the interior of the installation volume can take place. The light-permeable areas are, for example, thick panes of glass. The crucial disadvantage of such built-in parts lies in the fact that the mechanical stability of the conduit system is considerably reduced. For a number of polymers, particularly in the case of spontaneously exothermically reacting polymers, a reduction of this type in the mechanical stability cannot be tolerated, because there is a risk of fracturing in case of a spontaneous exothermic reaction.

On the other hand, measurements by means of gas chromatography fail because of the manual sample drawing, analysis times that are too long and time-consuming sample preparation.

A further method and a further device for inspecting polymer melts are described in DE-A-199 34 349. According to DE-A-199 34 349, a specific quantity of the polymer melt is withdrawn from the installation and fed to a measuring device. As it passes through the measuring device, a number of rheological, visual and chromatographic analyses of the polymer melt are made. Polymer decomposition products and contaminations are examined with the help of gas chromatography, optionally coupled to a mass spectrometer. Unlike the method according to the invention, in DE-A-199 34 349, no sample gas formed from the polymer melt is withdrawn directly from the installation volume and fed to a mass spectrometer. In DE-A-199 34 349, the gas sample is withdrawn from the measuring section outside of the installation volume and only guided to the mass spectrometer after separation by gas chromatography. In contrast to the device according to the invention, the device of DE-A-199 34 349 therefore has no gas line that can be connected to the installation volume in a manner that allows fluids to be conducted.

In addition, in the case of all visual methods, the utilisable spectrum, with its strong overlappings or widenings of the vibrational bands, limits the precision of the analysis to such an extent that the identification and determination of the concentration in the sample can only be accomplished with a very extreme mathematical effort, if at all. Because ultimately, in spite of standardised design rules, no installation in its apparatus configuration is similar to the other, and even each individual installation has to be operated differently because of various raw materials with various contaminations, the process control in each installation must be readjusted to process parameters that are to be maintained in a stable form, in order to optimise the product quality, the catalyst and the catalyst concentration, as well as to minimise the by-products.

Altogether, the result is that in the area of polymer production, particularly by polycondensation, robust, precise and, above all, rapid, analysis methods are lacking.

The object of the invention is therefore to create a method and a device with which the production of a polymer can be rapidly, precisely and robustly monitored. Surprisingly, as a solution for this object, it has turned out that the method mentioned at the beginning achieves a very precise analysis and monitoring of the polymer production by means of guiding the sample gas directly from the installation volume to the mass spectrometer.

For the automatic analysis device mentioned at the beginning, the object is solved according to the invention by means of the provision of a connecting gas line, which can automatically open and close and which directly connects the mass spectrometer to the installation volume.

By using a mass spectrometer, the composition of the sample gas can be determined quickly and accurately, so that the measurement result can be used for controlling the process parameters of the production process. This is made possible by the gas line, which is capable of automatically opening and closing and by means of which the sample gas is automatically guided to the mass spectrometer and analysed. As a result of this measure, the composition of the by-products and decomposition products, as well as the vapours, can be determined by means of mass spectrometry during ongoing polymer production. It is no longer necessary to carry out sampling by hand.

The sample gas can, for example, be guided during the polycondensation directly from the installation volume, for example, in the form of the exhaust vapours. In the case of a liquid polymer blend, melt and/or solution, this can be partially vaporised in the area of a by-pass, wherein this vapour is then conveyed to the mass spectrometer after the activation of the shut-off device. Lasers, gas burners or electric heating apparatuses that heat up the polymer blend, melt and/or solution can be used for the vaporisation. In order to keep the sample gas from re-entering the installation volume in the case of liquid phases, a valve system or lock system can be provided, in which case the vaporisation takes place in a separate area.

In order to control the various steps during a sampling, the automatic analysis device can advantageously comprise a controller. Furthermore, a shut-off device, controlled by the controller and, for example, in the form of a one-way valve or multi-way valve, a cock or gate valve, can be provided for opening and closing the gas line. The shut-off device can automatically release the gas line via a signal from the controller, so that the sample gas is guided to the mass spectrometer. In order to achieve a transport of the sample gas in the gas line that is as fast as possible, a pumping apparatus, by means of which the sample gas can be conveyed to the mass spectrometer, can be provided.

According to a preferred development, the mass spectrometer has a measurement range of 1 AMU (atomic mass unit) and 2,000 AMU, in particular, however, a measurement range of from 5 AMU to 200 AMU. The components relevant for the polymer production can be analysed in these ranges.

In order to avoid deposits on the wall of the gas line during and/or after the measurement and sampling, and therefore in order to avoid interference with subsequent measurements, the gas line, in an advantageous development, can be heated. At the same time, the temperature of the gas line can lie, in particular, above the condensation temperature of the sample gas. For example, in the production of polyester from terephthalic acid and ethylene glycol, the gas line can be heated to a temperature of over 250° C., or, in the production of polycarbonate from diphenyl carbonate and bisphenol A, to over 350° C. The temperature of the gas line can also be adjusted depending on the processing stage at which the sampling site is located, and adapted to the temperature of, for example, the exhaust vapours at this site.

In a series of further advantageous developments, a cleaning or flushing apparatus can be provided, by means of which the gas line is cleaned of residues of the sample gas between separate samplings.

For example, the gas line can be flushed by a flushing gas, so that no deposits can form on the wall of the gas line between measurements. The flushing gas can preferably be heated to temperatures that correspond to at least the temperature of the withdrawn sample gas. The flushing gas can be an oxidizing gas, in particular, an oxygenated inert gas, so that residual matter and residues in the gas line are combusted. The flushing can take place in two stages, in that after the flushing with an oxidizing gas, a flushing with an inert gas takes place. Furthermore, before the next measurement, the gas line with the inert gas fill can be closed or sealed.

The flushing operation can be assisted by heating the gas line, so that residues in the gas line are combusted or vaporised and removed by the flushing gas. The heating can be achieved by increasing the heating temperature of the heating apparatus to a temperature that corresponds to at least the boiling point, flash point or ignition point of condensation products of the sample gas, or roughly 50° C. to 1,200° C.

A particularly advantageous development provides for the sample gas to be fed to the mass spectrometer from various sampling sites of the installation, distanced from one another, so that the composition of gas-like or vapour-like products can be examined at various points in the installation and in various stages and processing states of the polymer. For this purpose, it is possible to provide a manifold apparatus, which is controlled by the controller and, for example, which clocks the various sampling sites through to the mass spectrometer, so that the sample gas from these sites can be analysed.

In a further advantageous development, the transport of the sample gas in the gas line can take place in a transport gas, preferably an inert gas. In this case, the transport gas is advantageously fed to the sample gas at a high speed, for example, under pressure. In this way, the speed of the gas in the gas line can be increased in such a way that the sample gas reaches the mass spectrometer after only a short time. As a result of the high speed of the gas, the risk of deposits in the gas line is also reduced.

The quantity and pressure of the transport gas fed to the sample gas can be set by a dosing mechanism, for example, in the form of a valve. The portion and speed of the transport gas can, for example, be set, depending on the respective gas line from the sampling site to the mass spectrometer, in such a way that the time for transporting the sample gas from the sampling site to the mass spectrometer is roughly the same for all gas lines.

For example, the design and functioning of a mass spectrometer is described in the book: Skoog, Douglas A., “Instrumentelle Analytik: Grundlagen-Geräte-Anwendungen”, Springer-Verlag, 1996. Reference is made to this book, in its entirety, with respect to the design and functioning of mass spectrometers.

Calibration spectra are saved in a spectrum library in the mass spectrometer,

wherein these calibration spectra represent, in advance, mass spectra for the known components, by-products and decomposition products, as well as vapours, for the particular polymer blend, melt and/or solution to be monitored. Because in mass spectroscopy, the mass spectrum of a substance results from several components and/or fragments as a linear combination of the mass spectra of these components and/or fragments, each weighted according to the respective portion in the substance, the composition of the sample gas can be determined by simple algorithms for the solution of linear systems of equations, using the calibration spectra.

The composition of the sample gas, for example, an exhaust vapour, can be used for controlling the process parameters, such as the concentration of the monomers and the catalyst, for example, as well as for controlling the temperature and pressure in the installation volume.

Particularly in the case where several sampling sites are used, a group of characteristics can be used, by means of which the process parameters to be selected in the installation can be unambiguously allocated to the measurement results at the sampling sites during operation. Such a characteristic map can also be developed in the form of a neuronal network. The advantage of such a characteristic map lies in the fact that it can be determined on a purely empirical basis, so that it is possible to implement a controlling of the installation or of sub-systems of the installation with only a slight effort. Furthermore, because the controlling is based on empirically determined interactions among the input quantities or quantities of state and the output parameters or process parameters, the method based on the characteristic map can be used for a large number of various production methods.

An additional surprising side-effect arises as a result of the fact that, by means of the automatic analysis device according to the invention and the method according to the invention, it is possible to monitor the vacuum tightness of sections of the installation volume working with a negative pressure. For this purpose, the escape of three components present in the ambient air of the installation, such as oxygen, nitrogen, carbon dioxide and/or argon, can advantageously be monitored in the sample gas. Should these components be detected in the sample gas in concentrations that are higher than a predetermined alarm concentration, it indicates a leak through which these components are being drawn out of the ambient air and into the installation volume. A particularly reliable leak monitoring results when argon is used as an indicator for a leakage.

The automatic analysis device, as well as the method according to the invention, can also be used in the production and processing of by-products of polymer production.

In the following, various embodiments of the invention are explained by way of example, with reference to the included drawings. In these explanations, the same reference numbers are used in the various embodiments for elements with the same or similar design and/or the same or similar function. At the same time, the various features in the individual embodiments can, as explained above, be combined in any way.

Shown are:

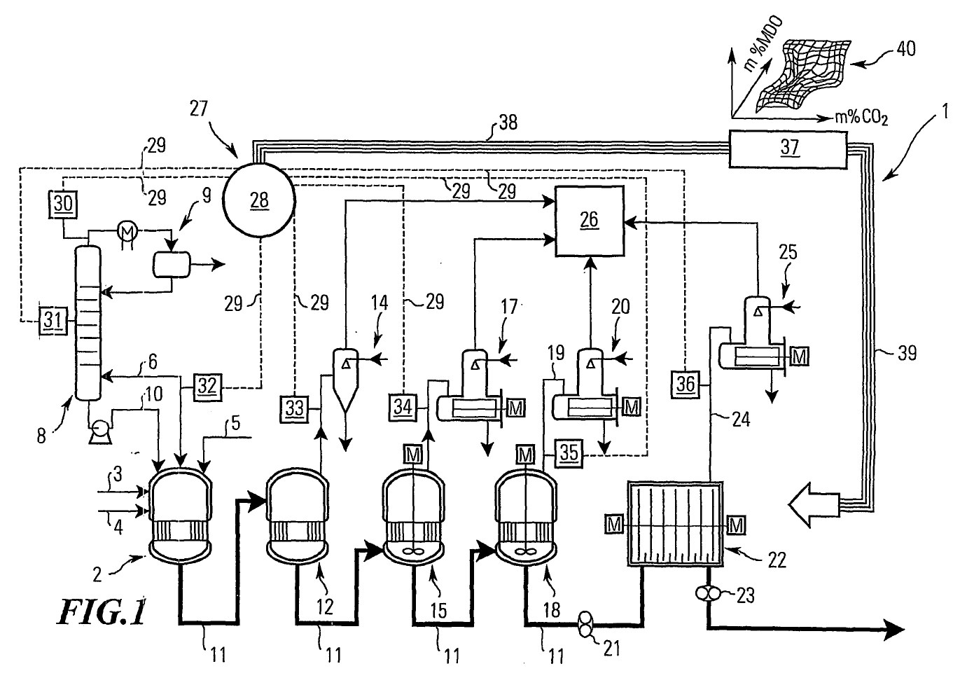

FIG. 1 an installation for polyester production, in a schematic view;

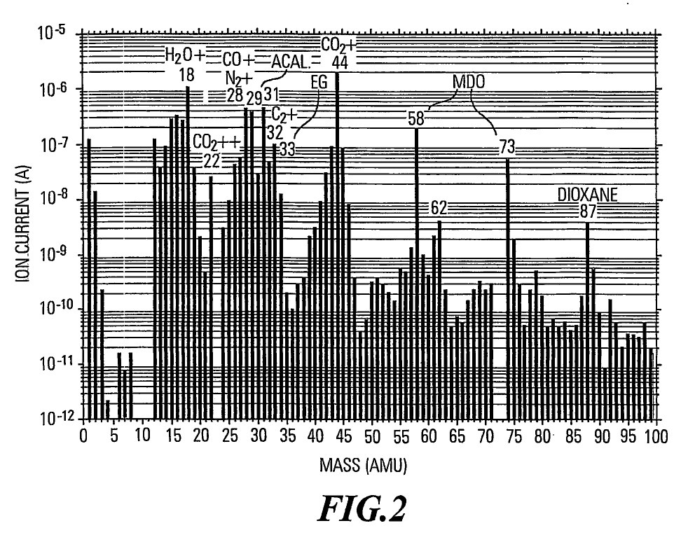

FIG. 2 a schematic depiction of a mass spectrum;

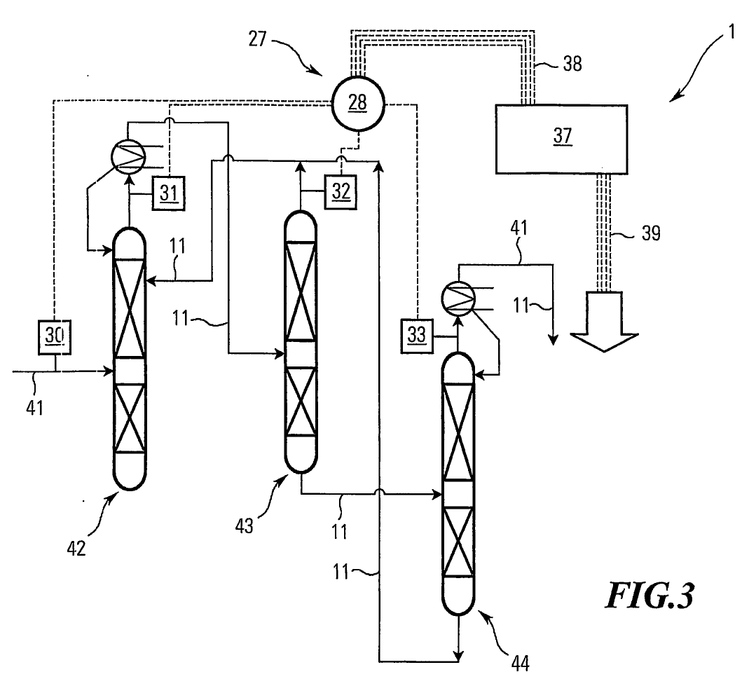

FIG. 3 an installation for the purification of tetrahydrofurane, in a schematic view;

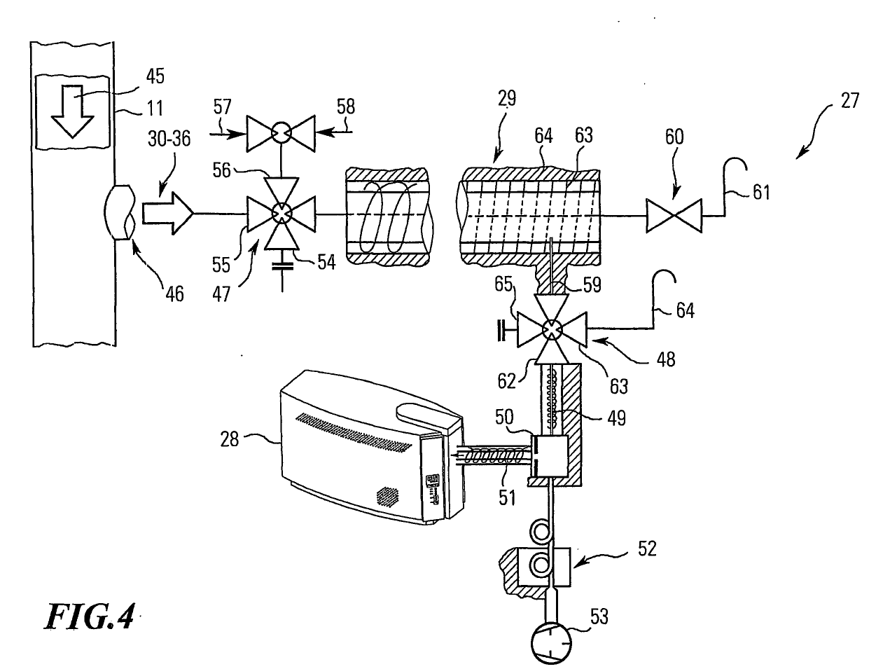

FIG. 4 an embodiment of an automatic analysis device in a schematic representation.

FIG. 1 schematically shows an installation 1 for the production of polyester, representative for a polycondensation process comprising multiple process steps. An installation of this kind for the production of polyester by means of polycondensation is, for example, described in DE-A-3 544 551.

Fed to a pre-esterification stage 2 of the installation 1, shown by the arrow 3, is a first monomer, such as terephthalic acid, diphenyl carbonate or dimethyl terephthalate, and, symbolically represented by the arrow 4, a second monomer, such as, ethylene glycol, bisphenol A or diethylene glycol, for example. Furthermore, a catalyst 5 is fed to the pre-esterification stage 2. The monomers 3, 4 and the catalyst 5 are intensively mixed together in a specified ratio in the pre-esterification stage 2 and brought to a temperature at which they react or transesterify to the esterification product at a suitable speed. The largest quantities of cleavage products, such as water, glycols or phenols, are released in this step. In the case of an acid-catalysed reaction mechanism, the mass of by-products is the largest in the pre-esterification stage.

The cleavage products created during the pre-esterification are fed to a breakdown product column or rectification column 8 via a cleavage product by-pass 6. A portion of the base raw material can be recovered from the cleavage product column 8 via a distillation or rectification system 9 and fed back to the pre-esterification stage again via a conduit 10.

The polymer blend, melt and/or solution is guided from the pre-esterification stage 2 to a post-esterification stage 12 via a conduit system 11. In the following, only a polymer melt will be mentioned, by way of example. The exhaust vapour is run out of the post-esterification stage 12 to a cleaning stage 14, for example, a spray condensation system, via a post-esterification exhaust vapour by-pass 13. From the post-esterification stage 12, the polymer blend, melt and/or solution is fed to a pre-condensation stage in the form of a mixing tank 15 via a conduit system 11.

The exhaust vapour is fed from the pre-condensation stage 15 to a further cleaning stage 17 via a pre-condensation exhaust vapour by-pass 16. In this connection, the configuration of the cleaning stage 17 essentially corresponds to the configuration of the cleaning stage 14.

After the pre-condensation stage 15, the polymer blend, melt and/or solution is fed to the post-condensation stage 18 via the conduit system 11. Again, the exhaust vapour from the post-condensation stage 18 is cleaned, via a by-pass 19, by means of a cleaning stage 20, whose configuration essentially corresponds to the configuration of the cleaning stage 14.

In the post-esterification stage 12, the pre-condensation stage 15 and the post-condensation stage 18, the longer-chain molecules are generated at rising temperatures between 200° C. and 350° C. and decreasing pressures between 2,400 hPa and 0.5 hPa.

The polymer melt from the post-condensation stage 18 is ultimately fed in the conduit system 11 via a pump 21 to a final reactor 22, from which the end product is conveyed via a further pump 23. The exhaust vapour from the final reactor 22 is fed to a further cleaning stage 25 via a by-pass 24. Again, the configuration and function of this cleaning stage essentially correspond to the configuration of the cleaning stage 14. The lowest pressure in the installation 1 can be found in the final reactor 22, which is characterised by the generation of high surface values in the case of a very viscous material and the product with the highest molecular weight.

In comparison to the pre-esterification stage 2, incrementally smaller quantities of by- and cleavage products and vapours occur in the reactor systems 12, 15, 18 and 22.

As can be seen in FIG. 1, a shared vacuum system 26 with a vacuum pump (not shown) is used for the extraction of the exhaust vapour from the post-esterification stage 12, the pre-condensation stage 15, the post-condensation stage 18 and the final reactor 22. A negative pressure for the conveyance of the exhaust vapour is generated by the vacuum system in the exhaust vapour by-pass 13, 16, 19, 24 and in the assigned cleaning stages 14, 17, 20, 25. At the same time, volatile components are removed from the polymers by the negative pressure.

The polymer is produced in the installation 1 during its retention time in the installation volume from the pre-esterification stage 2 to the final reactor 22; also included in the installation volume are the volumes of the cleavage product 8 and the cleaning stages, which are filled with substances that are derived from the polymer.

According to the invention, the installation 1 is now equipped with an automatic analysis device, given the reference number 27 overall, wherein the configuration and function of this automatic analysis device are described in more detail in the following.

The automatic analysis device 27 has a mass spectrometer 28, which is connected to a multiple number of schematically represented sampling sites 30, 31, 32, 33, 34 and 35 via a multiple number of gas lines 29. Each of the sampling sites 30 to 35 is connected to the installation volume, preferably at positions at which exhaust vapours accumulates.

In the case of the installation 1 for polyester production by polycondensation shown in FIG. 1 by way of an example of an application of the automatic analysis device 27, one sampling site 30 is located on the head of the cleavage product column 8. A further sampling site 31 is located on the intermediate column plate, where the exhaust vapour accumulates. A further sampling site 32 is located at the exhaust vapour by-pass 6 of the pre-esterification stage 6, and the remaining sampling sites 33 to 36 are located at or in the respective exhaust vapour by-passes 13, 16, 19, 24 of stages 12, 15, 18 and 22.

Each of the gas lines 29 is heated, wherein the temperature rises with the progressive process stages. For example, the gas lines of sampling sites 30, 31 and 35 are heated to 260° C., and the gas line to the sampling site 36 at the final reactor 22 is heated to 290° C. Preferably, the temperature of the gas lines 29 is higher than the condensation temperature of the component of the sample gas that condenses at the highest temperature. The gas lines 29 are manufactured of, for example, glass or metal, preferably stainless steel, for example, 1.4571, and their diameter lies between 0.2 and 25 mm.

A mass spectrum is automatically calculated by the mass spectrometer 28 from the sample gas that is guided through the gas lines 29 to the mass spectrometer 28. FIG. 2 shows such a mass spectrum by way of example. With regard to the design and the functioning of the mass spectrometer, reference is made to the corresponding section in the book: Skoog, Douglas A., “Instrumentelle Analytik: Grundlagen-Geräte-Anwendungen”, Springer-Verlag, 1996. For example, a quadrupole-broadband mass spectrometer from the Balzer Company, type HPA 2000, with a measurement range of from 1 AMU to 2,000 AMU, can be used as a mass spectrometer 28. A different mass spectrometer with a measurement range between 1 AMU and 500 AMU, advantageously however between 5 AMU and 200 AMU, can also be used. With this measurement range, it is possible to combine a high resolution of the mass spectra with complete registration of all components relevant to the polymer production.

As shown in FIG. 2, the portion of the components 3-methyl, 1.3 dioxalane (MDO), acetaldehyde or dioxane determined by the height of the bars in the mass spectrometer can be monitored by the mass spectrometer 28 and used for controlling the installation 1 and the reactor systems 2, 12, 15, 18, 22.

The pressures, temperatures, retention times, catalyst conditions and filling levels, as well as additional process parameters, can be selected in the installation 1 depending on the measured portion of these components. Preferably, the mass spectrum acquired from a single sampling site in this process is used for controlling the reactor system allocated to this sampling site. In this way, the process parameters of the post-esterification stage 12 are controlled by the mass spectrum from the sampling site 33. In particular, via the composition of the sample gas obtained from the sampling sites 30 and 31, for example, the quantity of the first or second monomer fed to the pre-esterification stage 2 can each be controlled.

The control of the reactor systems is done by means of a controller 37, to which is transmitted an analysis signal that is representative of the composition of the sample gas conducted via the respective gas line 29 via a preferably bi-directional data line 38. The controller 37 then controls the reactor systems 2, 8, 12, 15, 18, 22 of the individual reaction stages via a data bus 39, depending on the analysis signal 37. Furthermore, the process parameters selected or measured at the reactor system at a specific time can be received by the controller 37 via the data bus 39. For example, the mass spectrum or the concentration of one or more components of the by- and cleavage products and vapours, as measured by the mass spectrometer, can be present in electronic or digital form as the analysis signal.

For controlling the installation 1, the controller 37 has stored in it a characteristic map 40, by means of which those process parameters that are to be adjusted at the reactor system allocated to this sampling site are unambiguously allocated to the measured components of the sample gas from the various sampling sites. The control characteristic 40 shown in FIG. 1 only by way of example assigns the temperature T₂ to be adjusted at reactor system 2, for example, to the measured content in percent by mass of MDO and CO₂ in the sample gas withdrawn at the sampling site 31, i.e., to the exhaust vapour in the intermediate bottom of the column. The control characteristic 40 shown in FIG. 1 has the form of a surface area. If more than two components of the sample gas are assigned to more than one process parameter of the respective reactor system in the characteristic map 40, the resulting control characteristic is in the form of a multi-dimensional hypersurface that cannot be shown in a drawing.

The particular advantage of installation control by means of the automatic analysis device 27 consists of the control unit 37 being based on a purely empirically determined control process, which is implemented by means of the following calibration procedure:

In a first step, the installation 1 is adjusted to the stable production of polyester of high quality. In this operating state, the sample gases are then withdrawn at the sampling sites 30 to 36 and the components of said sample gases are automatically analysed by the mass spectrometer 28. The process parameters in this operation are then assigned to the composition of these sample gases as the first calibration points of the characteristic map 40.

Then the process parameters of the individual reactor systems are varied in a controlled manner, one after the other, with a stationary retaining phase maintained after each change. For example, initially only the temperature in the pre-esterification stage 2, beginning with the temperature in the setpoint operating state, is changed. Then, while keeping the temperature constant, only the retention time for the polymer blend, melt and/or solution in the pre-esterification stage 2 is varied, step by step.

This variation of the process parameters is performed for all reactor systems, one after the other. In each modified operating state, the sample gases withdrawn at the sampling sites 30 to 36 are then analysed by the mass spectrometer 28. In this way, one obtains the state of the sampling gases at the sampling sites 30 to 36 at a large number of operating points that deviate from the ideal operating state. The compositions measured at these deviating operating states are then assigned to those changes in the process parameters that are necessary in order to take up the ideal operating state.

In this way, one obtains a characteristic map 40 in the form of an assignment of compositions of the sample gas to the respective operating states of the installation 1 and to the process parameters to be adjusted.

The characteristic map 40 can be implemented in the controller 37 by, for example, a neuronal network that is trained by the composition of the sample gases at the sampling sites 30 to 36 determined by the mass spectrometer 28 and by the process parameters that are to be adjusted. Alternatively, the characteristic map 40 can also be implemented in the controller 37 in the form of multi-dimensional look-up tables or empirical compensating curves, such as polynomials or Fourier series.

FIG. 3 is a schematic representation of a further installation 1 for purification a by-product from a polycondensation. In the esterification and polycondensation of terephthalic acid with 1,4-butanediol, in addition to large quantities of water, tetrahydrofurane (THF) is also formed in a secondary reaction by ring closure. This product represents a valuable raw material which is used in the paint industry, as well as in the production of polymers. This cleavage product mixture, which interferes with the further progress of the reaction, can easily be separated from monomer 1,4-butanediol (BD) by distillation because of its low boiling point in comparison to BD. For further use in the production of polymers, the THF must be extracted with the highest level of purity.

In the case of the installation 1 of FIG. 3, tetrahydrofurane classified as “polymer grade” is relieved of the unwanted by-products or side-products by means of multiple-stage distillation and rectification using azeotropic blends while varying the pressure and temperature conditions. By tracking and adjusting the pressure, temperature and reflux conditions, it is possible through the use of the automatic analysis device 27 to initially reach and maintain for a longer time the quality class “polymer grade” with limitations in the ppm range with respect to the content of impurities, even in light of a strongly changing and varying composition of the input product 41, as is normally the case when there is a transfer out of a polycondensation process.

The cleavage product blend comes into the installation from a condensate tank (not shown in FIG. 3); it is drawn off at the sampling site 30, fed to the automatic analysis device 27 for recording of the input composition and analysed by the mass spectrometer 28. The composition determined there is passed on to the controller 37. The pressure, temperature and reflux ratio are pre-selected for a column 42 based on these results. The more highly volatile overhead product is registered by the sampling site 31, and the result of the analysis likewise goes to the controller.

This result is used for remote control of the reflux ratio. The overhead product 11 is passed on to the column 43 and fed in at an intermediate plate. This column 43, which consists of a enriching zone and a stripping zone, sees to it, by means of azeotropic distillation under pressure, that the flow 11 drawn off on the bottom is fed in to the central part of a last distillation stage 44 with a purity level that is already high.

The overhead product of the column 43 is removed at the sampling site 32 and, as shown, fed to the automatic analysis device, the mass spectrometer and the controller. By means of refluxing the top product of the column 43 into the column 42, a feedback system is created. Because the operating method and behaviour of the columns 42 and 43 influence the flow of the material leaving the column 42 and entering the column 44, it is necessary to monitor the composition of the top product from the column 44 through the sampling site 33 by means of the automatic analysis device 27 and the mass spectrometer 28, and to supply the results to the controller 37. This type of monitoring additionally ensures a high level of product purity.

In order to obtain a high level of product purity permanently and under conditions of a changing input composition, one must resort to complicated mathematical and statistical models in the control system, because the complex coupling and feedback control system places great demands on the control technique. The analysis of the system can, however, be simplified in an advantageous manner by the use of a neuronal network with self-learning functions for the control.

FIG. 4 is a more detailed schematic representation of the configuration of the automatic analysis device 27, as it is used in the installations 1 of FIG. 1 and FIG. 3.

From the conduit system 11 of installation 1 (not shown in FIG. 4), through which the by- or cleavage products or a vapour 45 formed from the polymer blend, melt and/or solution or from a by- or cleavage product are guided, a branch 46 runs to a gas line 29, permanently mounted to the branch, via a shut-off device 47. The gas line 29 is connected to a capillary system 49 via a further shut-off device 48, and said capillary system 49, in one branch, leads to the mass spectrometer 28 via a metering orifice 50 and a further measurement capillary 51 and, in another parallel branch, to a vacuum pump 53 via a cold trap 52.

The shut-off devices 47, 48 and the additional valves of the automatic analysis device 27 are transferred to the various switching states, described below, by an activation signal of the controller 37.

The shut-off device 47 can, for example, be designed in the form of a multiple-way valve, which can be transferred to a sealing position 54 in which the connection between the sampling sites 30 to 36 and the gas line 29 is interrupted. Furthermore, as shown in FIG. 4, the shut-off device 47 can be transferred to an open position 55 in which the gas line 29 is connected to the installation volume in a manner that allows the conductance of fluids. Finally, the shut-off device 47 can be transferred to a mixing position 56, in which a transport gas 57 or a flushing gas 58 can be led into the gas lines 29. Preferably, the connection between the installation volume and the gas line 29 is interrupted in the mixing position 56, so that neither the inert gas nor the flushing gas can reach the installation volume 11 when directed into the gas line.

At the end opposite each sampling site, the gas line 29 is provided with a branch 59 which leads to the mass spectrometer 28 and with an outlet 61 which can be closed with a valve 60 and which serves for venting.

The second shut-off device 48 is arranged between the gas line 29 and the mass spectrometer 28, with said shut-off device 48 being arranged in such a way that it can be transferred to a measurement position 62 in which the connection between the gas line 29 and the mass spectrometer 28 can be sealed in a gas-proof manner. In a cleaning position 63, the gas line 29 is connected to a drain 64. In the measurement position shown in FIG. 4, the shut-off device 48 connects the gas line 29 to the mass spectrometer 28. Finally, the shut-off device 48 can be transferred to a closed position 65, in which the mass spectrometer 28 is disconnected from the gas line 29.

When a sample gas is withdrawn from the installation volume, the shut-off device 47 is switched by, for example, the controller 37, in such a way that the installation volume is connected to the gas line 29, while the shut-off device 48 is switched in such a way that the gas line 29 is connected to the mass spectrometer 28. In this way, the sample gas can be conveyed by the pump 53 to the mass spectrometer 28.

In the case of longer gas lines 29, a transport gas 57, for example, an inert gas such as nitrogen, can be added to the sample gas, wherein the transport gas is guided under pressure into the gas line 29, where it mixes with the sample gas. As a result of the addition of the transport gas 57, which is under pressure, the transport speed of the sample gas to the mass spectrometer 28 increases, so that directly after the setting into the switching state 55, the measurement can be performed at the mass spectrometer 28. In the case of gas lines 29 of various lengths, the sample gas 47 can be added in a dosed amount by a dosing device (not shown in FIG. 4) in such a way that the sample gas, in spite of the differing lengths of the gas lines 29 of the various sampling sites 30 to 36, takes the same period of time from each of the sampling sites to the mass spectrometer 28.

After the completion of the measurement, the shut-off device 47 is transferred to the sealing position 56. In order to be able to perform the next measurement without interference from the preceding measurement, a cleaning gas 58 can be pumped into the gas line 29 at the same time in the mixing position. The cleaning gas 58 is preferably an oxygenated or oxidizing gas, by means of which residues in the gas line 29 from the preceding measurement or from the sample gas are combusted. If the shut-off device 47 takes on the mixing position 56, the shut-off device 48 is transferred to the cleaning position 63 and, at the same time, the connection between the gas line 29 and the mass spectrometer 28 is closed. In addition, the valve 60 can be opened to connect the gas line 29 to the outlet drain 61.

Following the flushing of the gas line 29 with the cleaning gas 58, there can be a switch by the shut-off device 47 to the transport gas 57 and valves 60 and 48 can be closed, so that after the cleaning with the flushing gas, a gas line 29, filled with transport gas, is available and ready for the measurement.

The gas line 29 is provided with a heating apparatus 63 and, preferably, with an insulating jacket 64. The gas line 29 is heated by the heating apparatus 63 to a temperature, which corresponds to at least the condensation temperature of the component of the sample gas that is the first to precipitate. In the production of polymer plastics, this temperature can, in particular, lie between 260° C. and 350° C.

Furthermore, the capillaries 49 and 51 and the metering orifice 50, which, because of its predetermined diameter, allows only a standardised volumetric flow rate to the mass spectrometer, are heated. To promote the cleaning effect, the temperature of at least the heating apparatus 63 can be increased in such a way that the combustion of deposits in the gas line 29 is supported while the flushing gas is guided through the gas line 29.

In order to be able to operate a number of sampling sites 30 to 36 with just a single mass spectrometer 28, the shut-off devices 47 and/or 48 can be formed as manifold apparatuses which, clocked one after the other, put through the various sampling sites 30 to 36 to the mass spectrometer 28 and take on the cleaning position in between. Particularly in the case of this embodiment with clocks of the same length, it is advantageous if the transport gas 57 is fed in such a way that the same transport times to the mass spectrometer 28 are achieved, in spite of the various lengths of the gas lines 29.

The number of sampling sites 30 to 36 is given in this description only by way of example. According to the invention, at least one sampling site 30 is provided.

Any inert gas can be used as the transport gas. The content of the transport gas can be easily compensated in the analysis signal by means of preceding calibration measurements, in that that components of the sample gas that appear in the mass spectrum are not considered in the analysis.

The following Table 1 shows two example trials which were conducted with the installation of FIG. 1 (example 1) and FIG. 3 (example 2). In each of these, the installations were controlled depending on the analysis signal. The two example trials clearly show that as a result of the use of the automatic analysis device according to the invention and as a result of the control depending on the composition of the sample gas, both the absolute quantity of the respective by-products produced and the variations that arose during the production of the end product could be considerably reduced.

TABLE 1

| | | | By-products | | | By-products | | |
|---|---|---|---|---|---|---|---|---|
| | | | without | | | with | | |
| | | | automatic analysis device | | | automatic analysis device | | |
| Example | Product | | | | Variation | | | Variation |
| 1 | PET | TPA | MDO | 0.25% | ±80% | MDO | 0.1% | ±5% |
| | | EG | Acetaldehyde | 0.5% | ±65% | Acetaldehyde | 0.2% | ±5% |
| | | | Dioxane | 0.3% | ±78% | Dioxane | 0.1% | ±5% |
| | | | EG | | ±5% | EG | | ±1% |
| | | | consumption: | | | consumption: | | |
| | | | 345 kg/to | 100 ppm | | 345 kg/to | 30 ppm | |
| | | | PET | | | PET | | |
| | | | O₂ leakage | | | O₂ leakage | | |
| 2 | THF | THF, | THF | 99.7% | ±0.4% | THF | 99.95% | ±0.05% |
| | | H₂O, | H₂O | 0.2% | ±0.3% | H₂O | 0.02% | ±0.005% |
| | | Butanol, | Butanol | 0.1% | ±0.3% | Butanol | 0.01% | ±0.005% |
| | | Butenol | Butenol | 250 ppm | ±300 ppm | Butenol | 50 ppm | ±20 ppm |

1. A method for monitoring a composition of a polymer blend, melt, solution or combination thereof, used to produce a polymer, comprising:
(a) guiding the polymer blend, melt, solution or combination thereof through an installation volume;
(b) withdrawing a sample gas that is formed from the polymer blend, melt, solution or combination thereof, from the installation volume; and
(c) feeding the sample gas through a gas line connected to the installation volume and directly to a mass spectrometer, wherein the mass spectrophotometer automatically outputs an analysis signal representing the composition of the sample gas.

2. The method according to claim 1, wherein a transport gas is added to the sample gas in the gas line.

3. The method according to claim 2, wherein the transport gas is heated.

4. The method according to claim 2, wherein the transport gas is fed under pressure.

5. The method according to claim 1, wherein the gas line is heated.

6. The method according to claim 5, wherein the gas line is heated to at least the condensation temperature of the sample gas.

7. The method according to claim 5, wherein the gas line (29) is heated to at least 200° C.

8. The method according to claim 7, wherein the gas line (29) is heated to at least 290° C.

9. The method according to claim 1, further comprising:
(d) flushing the gas line with a flushing gas.

10. The method of claim 9, wherein the flushing gas is heated.

11. The method according to claim 10, wherein the flushing gas is heated to a temperature of at least the condensation temperature of the sample gas.

12. The method according to claim 9, wherein the flushing gas is an oxidizing gas.

13. The method according to claim 1, wherein the installation volume comprises a plurality of sampling sites and wherein the sample gas is withdrawn in step (b) from the plurality of sampling sites of the installation volume in an alternating manner.

14. The method according to claim 13, further comprising connecting the plurality of sampling sites each individually to the mass spectrometer by an electronically controlled shut-off device.

15. The method according to claim 14, further comprising connecting the sampling sites to the mass spectrometer according to a predetermined adjustable clock.

16. The method according to claim 1, wherein the polymer is produced by polycondensation.

17. The method according to claim 1, wherein the sample gas comprises an exhaust vapour of a reactor system.

18. The method according to claim 9, further comprising closing the connection between the installation volume and the gas line during step (d).

19. The method according to claim 9, further comprising interrupting the connection between the gas line and the mass spectrometer during step (d).

20. The method according to claim 1, further comprising:
(e) using the analysis signal of step (c) to control a reactor system.

21. An automatic analysis device that is arranged in such a way that it can be built into an installation for the production of a polymer from a polymer blend, melt, solution or combination thereof, that is guided through an installation volume, having at least one gas line, said gas line being developed in such a way that it can be connected to the installation volume in a manner that allows the fluids to be conducted and can be opened and closed automatically, and
at least one mass spectrometer to which a sample gas formed from the polymer blend, melt, solution or combination thereof, can be fed through the gas line during the production of the polymer, wherein an analysis signal that is representative for the composition of the sample gas can be outputted by the mass spectrometer.

22. The automatic analysis device according to claim 21, further comprising a controller and a shut-off device controlled by a controller are provided, wherein the gas line can be automatically released by the shut-off device depending on an activation signal from the controller.

23. The automatic analysis device according to claim 21, further comprising a pumping apparatus, by means of which the sample gas can be conveyed to the mass spectrometer.

24. The automatic analysis device according to claim 21, wherein the gas line is arranged in such a way that it can be shifted into a flushing state by means of being separated from the installation volume and having a flushing gas flow through it.

25. The automatic analysis device according to claim 21, further comprising a heating apparatus, by means of which the gas line can be heated.

26. The automatic analysis device according to claim 21, further comprising a plurality of sampling sites, the plurality of sampling sites being distanced from one another, and flowing into a shut-off device, and in that by means of a controller one sampling site at a time can be connected to the mass spectrometer via the shut-off device in a way that it allows fluids to be conducted.

27. An installation for the production of a polymer, comprising at least one reactor system and an automatic analysis device according to claim 21.

28. The installation according to claim 27, further comprising a controller, by means of which at least one reactor system can be controlled, depending on the analysis signal.

29. The installation according to claim 27, wherein the installation is designed as a polycondensation installation.
